(19) United States
(12) Patent Application Publication
(10) Pub. No.: US 2012/0175475 A1
(43) Pub. Date: Jul. 12, 2012

(54) ROTATABLE TABLE LEVELING DISK

(76) Inventor: Scott McErlane, Key Biscayne, FL (US)

(21) Appl. No.: 13/005,050

(22) Filed: Jan. 12, 2011

(51) Int. Cl. A47B 91/12; F16M 11/24

(52) U.S. Cl. 248/188.2

(57) ABSTRACT

This invention is directed to a uni-body constructed leveling device used to shore and stabilize a furniture leg. This leveling device may include three primary components. First, it has a bottom disk having a first surface and corresponding second surface which is essentially flat and circular. Affixed to the second surface is a vertical shaft having a first end, a second end and a middle column disposed between both the first and second ends. The first end of the vertical shaft is rigidly affixed to the second surface. Lastly, a plurality of platforms are affixed to the bottom disk. Each platform has a unique elevation above the bottom disk. Moreover, each platform is essentially parallel to the second surface of the bottom disk.

### FIELD OF THE INVENTION

This invention is directed toward a rotatable table leveling disk which can be placed under a furniture leg and twisted to shore up and balance a piece of furniture. Such device may take the form of a circular disk having a vertical shaft which includes a plurality of stepped levels.

### BACKGROUND OF THE INVENTION

In both restaurants and cafes, wobbly tables are a problem both as an annoyance for customers and as a detraction from the table's function of supporting dinnerware and other articles on it. Whether floors are made of wood, tile, concrete, terrazzo, or any other material, the floor surface is seldom perfectly flat. For this purpose, the legs or pedestals of many tables are provided with glides which are typically mounted by screw threads to enable the glides to be vertically adjusted for stable support of the table on floor surfaces which are not perfectly level.

The difficulty with conventional table glides is that it is a time consuming process to properly adjust them. In a busy restaurant setting, time is simply not available to make such adjustments each time a table is moved. Such adjustments would likely require that the table be tipped up or turned down on its side for access to the glide with a tool if necessary. Accordingly, such adjustments may be an unacceptable disruption in any event. Finally, even if the table glides are properly adjusted once, readjustment would be necessary each time the table is moved to accommodate combining tables or different table arrangements.

Even on level surfaces, adjustment may be necessary when combining tables to level them relative to one another. When two tables are moved together, they not only need to be stabilized at that new position, but also leveled with one another to eliminate a ledge at the joint since it may be necessary for a patron to be seated at the junction where two tables meet.

In an effort to avoid wobbly tables, restaurants (and related establishments) have been known to use cardboard matches or plain wood wedges below selected table glides for leveling and stabilizing wobbly tables. The matchbooks are somewhat compressible and aesthetically detract from what otherwise may be a very elegant restaurant atmosphere. The common wood wedge provides vertical support, but no lateral support. Accordingly, if the table is bumped or moved slightly, it can be moved off of either of these supports. Furthermore, it is difficult to insert a common wedge under the glides of a table pedestal because the precise position of the table glide cannot be seen unless the waiter gets down on hands and knees with his eyes near the floor.

While there have been several attempts at creating an improved wedge device for shoring up tables, each has limitations as an effective leveling device. U.S. Pat. No. 5,249,767 issued on Oct. 5, 1993 to Floyd E. Mellen (“the '767 Patent”) is directed to a wedge having a cavity formed on the top surface that extends from the forward end to the rearward end. Such wedge may likewise include a pair of feed to guide the wedge onto the table leg to create a support.

Other advances to the table leveling systems include a plurality of wedges all of which slide amongst themselves. One example of such system is U.S. Pat. No. 4,858,865 issued on Aug. 22, 1989 to Rudolf Schrepfer (“the '865 Patent”). The '865 leveling mount relates to a three wedges which communicate with each other via a vertical pin. Through twisting a horizontal screw, each of the wedges slide in order to create a desired pile height.

Similar to the '865 Patent, U.S. Pat. No. 4,776,548 issued on Oct. 11, 1988 to Barry Bezenek relates to an assembly of two wedges. Here, the level system includes a primary wedge having two columns of teeth on the include surface which allows attachment of the second wedge called a “walker.” By affixing the walker onto the primary wedge via the teeth, a user can create a specific pile. However, this requires manually lift and then securing the walker to a desired height.

U.S. Pat. No. 5,492,292 issued on Feb. 20, 1996 to Jeffrey Richards is directed to two opposing wedge shaped pieced constructed to slide into each other to cause the furniture leg to be raised or lowered.

Accordingly, there is a need in the art of table leveling devices for a single member constructed device that allows the leveling of a furniture leg without need of manipulating multiple wedges towards or about each other. Such system should be easy to place under a furniture leg, as well as capable of adjustment once placed under the table.

### SUMMARY OF THE INVENTION

This invention solves many of the limitations found in current devices used to shore and/or stabilize furniture legs when on uneven surfaces. Moreover, the invention offers a uni-body constructed device that does not require the manipulation of multiple wedges or other devices to create a designed pile or height to stabilize the furniture. Accordingly, the technology instead offers the advance of a simple yet effective shoring device with reduced risk of dislodging due to extensive use of the suspect furniture.

In one embodiment of the invention, the device is directed to a leveling device having three part construction. More specifically, the device includes a bottom disk, a vertical shaft, and a plurality of platforms having various heights about the bottom base. More specifically, the bottom disk includes a first surface and corresponding second surface, both of which mirror each other in size and dimension. The second surface may include ornamentation such as a logo, symbol or information about an establishment's food or drink specials.

The second component of the leveling device is the vertical shaft which is perpendicularly attached to the bottom disk. Such vertical shaft includes a first end, a corresponding second end and a middle column disposed between both the first and second ends. Preferably, the first end of the vertical shaft is rigidly affixed to the second surface of the bottom disk. Optionally, the middle column includes a plurality of cavities sufficient to engage a furniture leg.

The third component are a plurality of platforms affixed to the bottom disk. Each platform has a unique elevation above the bottom disk and is essentially parallel to the second surface of the bottom disk. In one embodiment, there are a total of six different elevations about the bottom disk, through inclusion of a first platform, a second platform, a third platform, a fourth platform, and a fifth platform. In such embodiment, each platform has a unique elevation about the bottom disk. The combined surface of the second surface and these various five platforms may form a single ornamentation which shows a particular logo, symbol or related information.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 is a perspective view of the leveling device having stepped surfaces;

FIG. 2 is a side view of the leveling device of FIG. 1;

FIG. 3 is a top view of the spiral leveling device;

FIG. 4 is a perspective view of the spiral leveling device shown in FIG. 3;

FIG. 5 is a side view of the sloped leveling device; and

FIG. 6 is a top view of the sloped leveling device shown in FIG. 5.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### The Stepped Level Device

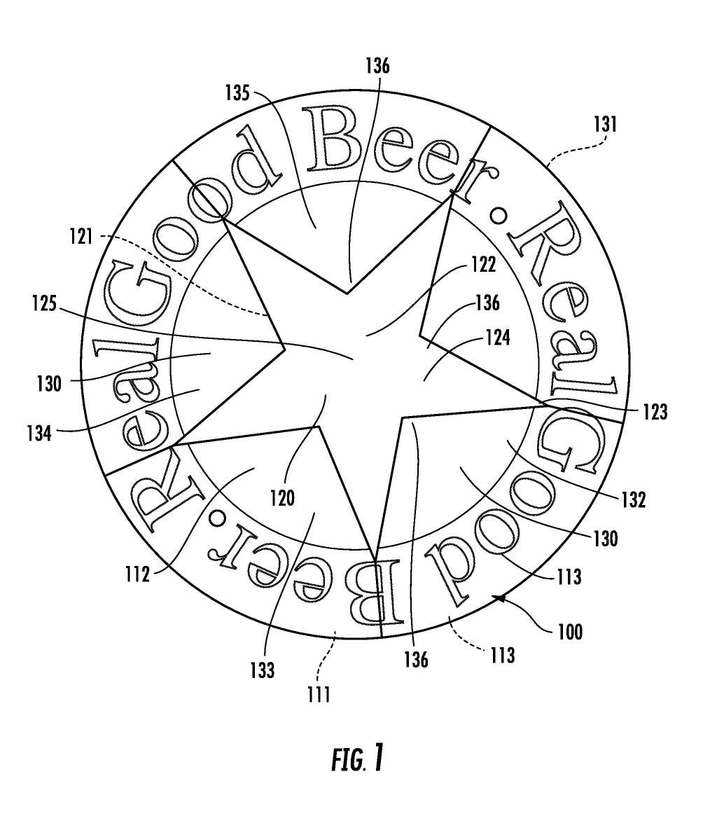

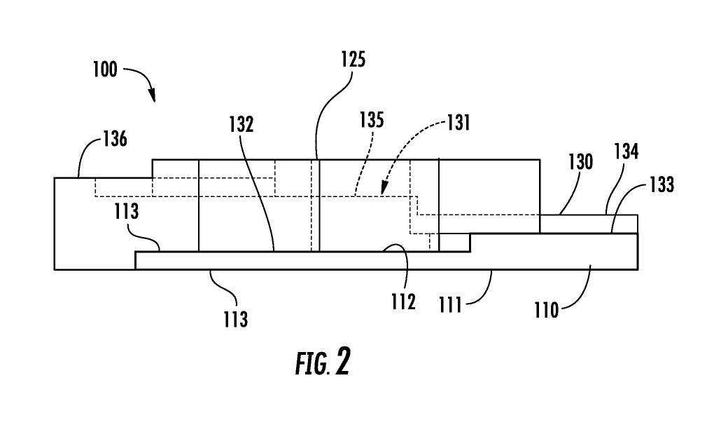

FIG. 1 and FIG. 2 illustrate, by way of example, one embodiment of the leveling device 100. As shown, the salient components of the leveling device 100 may include a bottom disk 110, a central vertical shaft 120, and a plurality of stepped levels 130. Each stepped level 130 is preferably affixed to the central vertical shaft 120 and is at a different height/elevation above the bottom disk 110.

As further illustrated in FIG. 1, the bottom disk 110 is essentially flat and circular. Such bottom disk 100 can optionally be other essentially rounded shapes such as octagons, etc. Moreover, such bottom disk 110 includes first surface 111 and a corresponding second surface 112. The first surface 111 preferably rests on a hard surface, such as a restaurant floor. Optionally, the first surface 111 may include ornamentation 113 which may include but is certainly not limited to various logos. Such logos may include beer, wine or spirits carried by a restaurant establishment or related business. Likewise, a portion of the second surface 112 may also include ornamentation 113 (along with the various stepped levels 130 positioned on top of the second surface 112).

Positioned on the second surface 112 of the bottom disk 110 is the central vertical shaft 120. As further shown in FIG. 1, such vertical shaft 120 is affixed essentially perpendicular to the second surface 112. Preferably (although it is not required) the vertical shaft 120 is positioned in the center of the bottom disk 110. Such vertical shaft 120 includes a first side 121, a top side 122, and a middle column 123 (positioned between both sides 121 and 122). As shown, the first side 121 is rigidly affixed to the second surface 112 of the bottom disk 110.

While the middle column 123 of the vertical shaft 120 is preferably tubular in shape and construction, it can be a variety of shapes and sizes. As shown in FIG. 1, the middle column 123 can have the cross section of a star or other known shape (i.e., a triangle, a square, a pentagon, and octagon, etc). Accordingly, the middle column 125 can include the cross section of a known logo, crest, or other personal identifier—or a related form of preferred ornamentation 124.

The third primary component of the leveling device 100 are a series of two or more stepped levels 130. As shown in FIG. 1 and FIG. 2, these stepped levels 130 may take the form of various height platforms 131. Each platform 131 is at a different height about the bottom disk 110. Preferably, each platform 131 is parallel (and therefore essentially horizontal with) the second surface 112. According, the plurality of these platforms 131 are affixed to the vertical shaft 120 such that each platform 131 has a unique elevation above the bottom disk 110.

As specifically illustrated in FIG. 1 and FIG. 2, the middle column 123 takes the form of a five point star. Attached to the middle column 123 are four platforms 131: a first platform 132, a second platform 133, a third platform 134, and a fourth platform 135. This creates five different elevations which a furniture leg may rest in order to be stabilized (i.e., shored up). The lowest elevation for the leveling device 100 is a portion of the second surface 112. Positioned at elevation above this portion of the second surface 112 is the first platform 132. Likewise, the second platform 133 is positioned at a height above the first platform 132.

When a middle column 123 takes the form of ornamentation 124 such as a five-point star, it may create a plurality of cavities 136. These cavities 136 allow a furniture leg to be more securely rest on the chosen platform 131 as well as abut the middle column 123. This helps reduce wobbling and reduces the risk of the leveling device 100 to become dislodged.

### Spiral Leveling Device

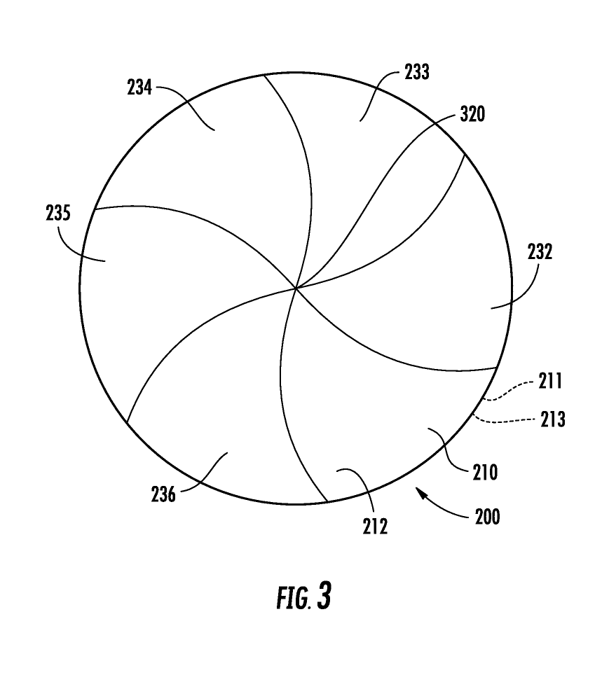

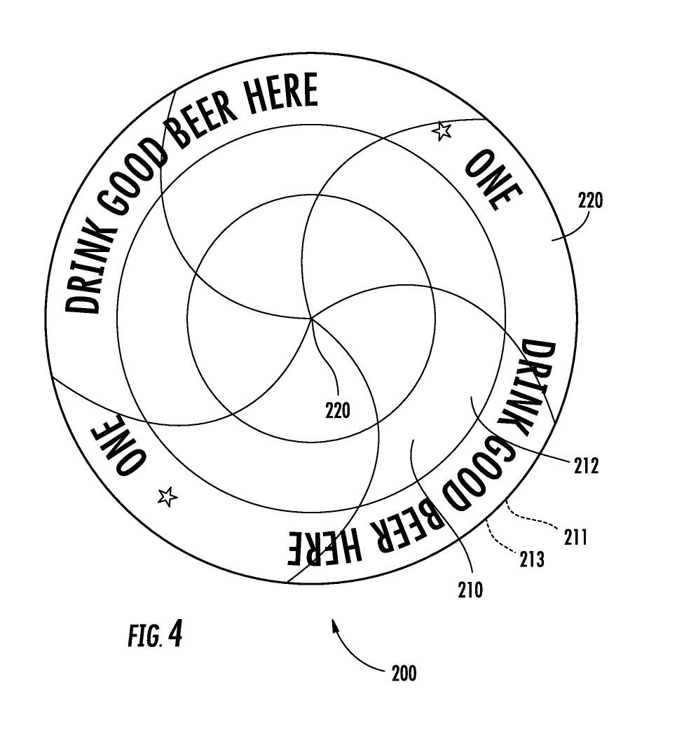

Both FIG. 3 and FIG. 4 illustrates, by way of example, a second embodiment of a spiral leveling device 200. As shown, the spiral leveling device 200 includes a flat bottom portion 210, a central point 220, and a plurality of stepped levels 230. Here, the bottom portion 210 is again essentially flat and circular having a first surface 211 and a corresponding second surface 212. Such first surface 211 can include ornamentation 213 in a variety of forms including a logo of the restaurant establishment, or the beer, wine or spirits served at such establishment. Moreover, such ornamentation 213 could include food or drink specials.

Positioned on top of the second surface 211 are a plurality of stepped levels 230 which are formed from multiple platforms 231. As shown, this embodiment includes six varying elevations based upon the attachment of five platforms 231: a first platform 232, a second platform 233, a third platform 234, a fourth platform 235 and a fifth platform 236. As shown each platform 232-235 includes an interior curved side 237 and a corresponding exterior curved side 238. As shown in FIG. 3, both curved sides 237 and 238 help create a spiral appearance and affect on the top surface of the spiral leveling device 100. The interior curved sides 237 help form a cavity 239 which again helps position and engage a furniture leg.

As further shown in FIG. 4, a section of each platform 232-235 may have a portion of graphical content to show ornamentation 120 in the form of a logo, design or statement. Such statement can be information about the restaurant establishment such as daily food or drink specials. Moreover, the placement of each of the various platforms 232-235 creates a central point 220 which is located preferably (but not necessarily) in the center of the bottom disk 210.

Through placement of the spiral leveling disk 200 below a furniture leg, the device can be rotated about the bottom disk 100 (see FIG. 3). By positioning the correct elevated platform 231, the device can engage the furniture leg. By rotating it within the cavity 239 created by the interior curved side 237, the furniture leg is essentially locked in to reduce the risk of becoming dislodged from the spiral leveling disk 200.

### Sloped Leveling Device

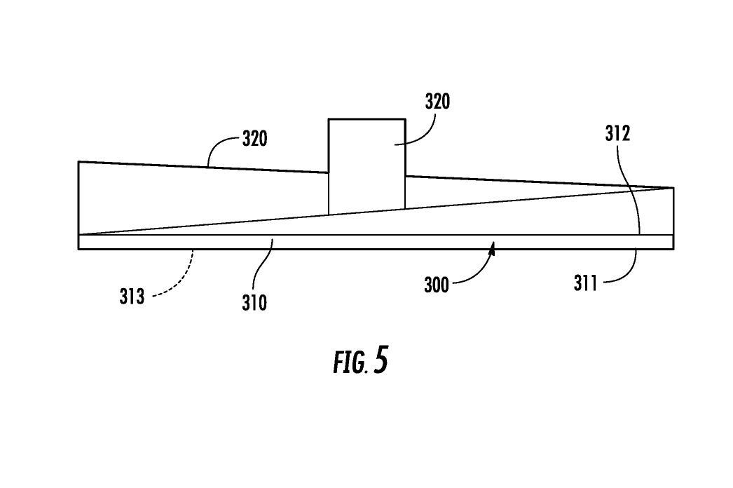

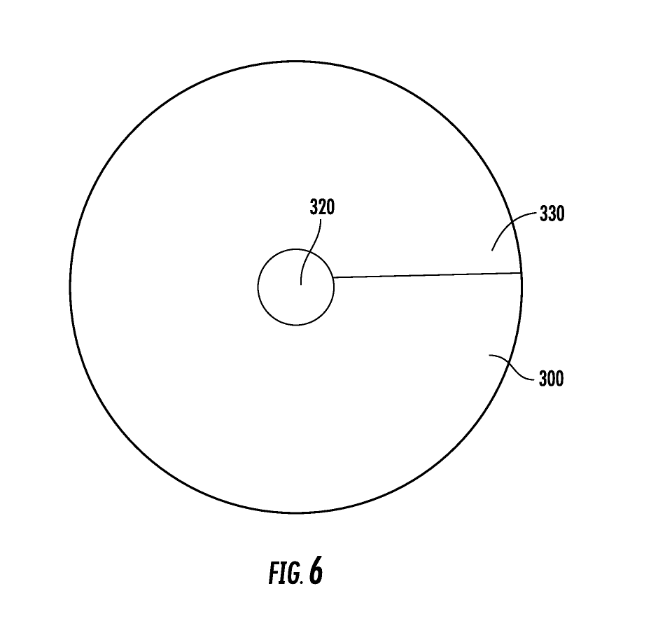

Both FIG. 5 and FIG. 6 show, by way of example, yet a third embodiment of the device in the form of a sloped leveling device 300. Such sloped leveling device 300 can be employed to help shore and/or stabilize a furniture leg, as well as alternatively act as a door stop. As shown, the sloped leveling device 300 may include a bottom disk 310, a central vertical shaft 320, and a single inclined spiral slope 330. Such single inclined spiral slip 330 is affixed onto the central vertical shaft 320 to provide a gradual elevation above the bottom disk 110.

As further illustrated in FIG. 5, the bottom disk 310 is essentially flat and circular having a first surface 311 and a corresponding second surface 312. As with the other leveling devices 100 and 200, the first surface 311 of the sloped leveling device 300 can display a form of ornamentation 313 (such as a graphic, logo, etc.).

Positioned on the second surface 312 of the bottom disk 310 is the central vertical shaft 320. As further shown in FIG. 5, such vertical shaft 320 is affixed essentially perpendicular to the second surface 312. Preferably (although it is not required) the vertical shaft 320 is positioned in the center of the bottom disk 310. Such vertical shaft 320 includes a first side 321, a top side 322, and a middle column 323 (positioned between both sides 321 and 322). As shown, the first side 321 is rigidly affixed to the second surface 312 of the bottom disk 310.

As further shown in FIG. 5, the single inclined spiral slope 330 is a gradual slope that provide a larger range of elevations about the bottom disk 110. This allows a more custom fit and shoring of the furniture leg by simply rotating the bottom disk 110 about such leg. FIG. 6 offers an elevation view of the spiral slope 330 in light of the central shaft 320.

I claim:

1. A leveling device for shoring and stabilizing a furniture leg, the leveling device comprising:
a bottom disk having a first surface and corresponding second surface, the bottom disk being essentially flat and circular;
a vertical shaft having a first end, a corresponding second end and a middle column disposed between both the first and second ends, wherein the first end of the vertical shaft is rigidly affixed to the second surface; and
a plurality of platforms affixed to the vertical shaft, each platform having a unique elevation above the bottom disk, wherein each platform is generally parallel to the second surface of the bottom disk.

2. The leveling disk of claim 1, wherein the first surface includes ornamentation.

3. The leveling disk of claim 1, wherein vertical shaft includes a cavity sufficient to engage a furniture leg.

4. The leveling device of claim 1, wherein a cross section of the middle portion may be star like shape.

5. The leveling device of claim 1, wherein the plurality of platforms includes six different elevations including a first platform, a second platform, a third platform, a fourth platform, and a fifth platform, and wherein each platform has the unique elevation about the bottom disk.

6. The leveling device of claim 5, wherein each surface of the various platforms forms an ornamentation.

7. A leveling device for shoring and stabilizing a furniture leg, the leveling device comprising:
a bottom disk having a first surface and corresponding second surface, the bottom disk being essentially flat and circular; and
a plurality of platforms elevated above the bottom disk, each platform having both an interior curved side and a corresponding exterior curved side; wherein the interior curved side forms a cavity to engage a furniture leg.

8. The leveling disk of claim 7, wherein the first surface includes ornamentation.

9. The leveling device of claim 7, wherein the plurality of platforms includes six different elevations about the bottom disk, through inclusion of a first platform, a second platform, a third platform, a fourth platform, and a fifth platform, wherein each platform has a unique elevation about the bottom disk.

10. The leveling device of claim 9, wherein each surface of the various platforms forms a single ornamentation.

11. A leveling device for shoring and stabilizing a furniture leg, the leveling device comprising:
a bottom disk having a first surface and corresponding second surface, the bottom disk being essentially flat and circular;
a vertical shaft having a first end, a corresponding second end and a middle column disposed between both the first and second ends, wherein the first end of the vertical shaft is rigidly affixed to the second surface; and
an inclined spiral slope having a plurality of elevations above the bottom disk.

12. The leveling disk of claim 11, wherein the first surface includes ornamentation.

13. The leveling device of claim 9, wherein spiral slope includes ornamentation.
